(19) United States
(12) Patent Application Publication
(10) Pub. No.: US 2016/0265708 A1
(43) Pub. Date: Sep. 15, 2016

(54) LEAK CHECK DEVICE

(71) Applicant: TOYOTA JIDOSHA KABUSHIKI KAISHA, Toyota-shi (JP)

(72) Inventors: Keisuke Minai, Nisshin-shi (JP); Koji Nagata, Toyota-shi (JP); Masaharu Ichise, Kiyosu-shi (JP); Masahiro Kuroda, Toyota-shi (JP); Shigeru Shibanuma, Nisshin-shi (JP)

(73) Assignee: TOYOTA JIDOSHA KABUSHIKI KAISHA, Toyota-shi (JP)

(21) Appl. No.: 15/062,700

(22) Filed: Mar. 7, 2016

(30) Foreign Application Priority Data
Mar. 13, 2015 (JP) 2015-051044

(51) Int. Cl. F16L 55/11

(52) U.S. Cl. CPC F16L 55/11

(57) ABSTRACT

A leak check device is for a seal structure of a junction between a first component and a second component. The seal structure is configured such that a fluid passage is defined inside the first and second components connected together, a seal member is attached to the first component, and the seal member prevents leakage of a fluid through the junction. The leak check device includes a test plug configured such that (a) the test plug includes an attachment portion to which the seal member is attached, (b) the attachment portion is connected to the second component separated from the first component, (c) a closed space is defined by an inner peripheral surface of the second component, an outer peripheral surface of the seal member, and an outer peripheral surface of the attachment portion, and (d) the test plug includes an introduction portion through which a test fluid is introduced into the closed space.

### INCORPORATION BY REFERENCE

The disclosure of Japanese Patent Application No. 2015-051044 filed on Mar. 13, 2015 including the specification, drawings and abstract is incorporated herein by reference in its entirety.

### BACKGROUND OF THE INVENTION

1. Field of the Invention

The invention relates to a leak check device.

2. Description of Related Art

In related art, for example, a fuel supply system for an internal combustion engine includes a plurality of components connected to each other to define (form) a fluid passage through which a fluid (e.g., fuel) flows, and is provided with a seal structure configured such that a seal member provided at a junction between the components prevents the fuel inside the fluid passage from leaking to the outside through the junction. Specifically, the components that define the fluid passage include a prescribed first component and a second component that is a component other than the first component. To connect the first component and the second component to each other, a seal member is attached to a portion of the first component to be connected to the second component, and the portion is connected to a connection portion of the second component to be connected to the first component. Thus, the seal member attached to the first component prevents the fluid inside the fluid passage from leaking to the outside through a junction between the first component and the second component.

In the seal structure, a seal check device as described in, for example, Japanese Patent Application Publication No. 10-300621 (JP 10-300621 A) may be used to check the sealing performance of the seal member. The seal check device is used in the following manner. After the components that define the fluid passage have been connected to each other and a junction between these components have been sealed with the seal member, a fluid that is supposed to actually flow through the fluid passage is introduced into the fluid passage and the seal check device checks the sealing performance of the seal member. One of the components that define the fluid passage has a sealable through-hole defined (formed) in advance. The fluid is introduced into the fluid passage through the through-hole to check the sealing performance of the seal member. When sufficient sealing performance of the seal member is confirmed as a result of the check, the through-hole is sealed.

### SUMMARY OF THE INVENTION

The fluid passage defined (formed) by connecting the components to each other may be used for a long period of time. In such a case, among the components connected to each other to define the fluid passage, the component (first component) to which the seal member is attached may be replaced with a new one together with the seal member, or only the seal member that has been attached to the first component may be replaced with a new one. When a new seal member is used as in these cases, it is necessary to check, in advance, whether the new seal member has sufficient sealing performance.

The sealing performance of a new seal member is checked with the leak check device of JP 10-300621 A in the following manner. First, the components that have been connected to each other are disconnected from each other, so that the first component to which the seal member to be replaced is attached is removed from another component (second component). Then, the seal member that has been attached to the first component is replaced with a new one or the first component is replaced with a new one together with the seal member, and the first component is connected to the second component again and the other components are connected to each other again to define the fluid passage. Further, the through-hole defined (formed) in the prescribed component in order to introduce a fluid into the fluid passage is unsealed. Then, a fluid that is supposed to actually flow through the fluid passage is introduced into the fluid passage through the through-hole to check whether the new seal member has sufficient sealing performance. When sufficient sealing performance of the new seal member is confirmed, the through-hole is sealed.

When the leak check device of JP 10-300621 A is used to check the sealing performance of a new seal member, it is necessary to define the fluid passage by actually connecting the components including the first component to which the seal member is attached, and it is also necessary to introduce the fluid that is supposed to actually flow through the fluid passage into the fluid passage. Connecting the components that define the fluid passage and introducing the fluid that is supposed to actually flow through the fluid passage into the fluid passage require a lot of time and effort. It is thus inevitable that a lot of time and effort is required to check the sealing performance of the seal member newly provided through the replacement.

The invention provides a leak check device capable of checking the sealing performance of a seal member without a lot of time and effort.

A leak check device according to an aspect of the invention is used for a seal structure configured such that a seal member attached to a first component connected to a second component to define (form) a fluid passage prevents a fluid inside the fluid passage from leaking to an outside through a junction between the first component and the second component. The leak check device includes a test plug including an attachment portion to be connected to the second component separated from the first component. The attachment portion is connected to the second component with the seal member attached to the attachment portion. The test plug includes a blocking portion and an introduction portion. The blocking portion turns a space inside the second component, the space being outward of the seal member, into a closed space when the test plug is connected to the second component. A test fluid is introduced into the closed space through the introduction portion.

With the configuration described above, when the first component that has been connected to the second component to define the fluid passage is replaced with a new one together with the seal member, or only the seal member is replaced with a new one, the sealing performance of a new seal member is checked by the following procedure. Specifically, the new seal member is attached to the attachment portion of the test plug, and the attachment portion of the test plug, to which the seal member has been attached, is connected to a connection portion of the second component that is separated from the first component. The first component is to be connected to the connection portion of the second component. The blocking portion of the test plug turns the space inside the second component, the space being outward of the seal member attached to the attachment portion of the test plug, into the closed space when the test plug is connected to the second component. The test fluid is introduced into the closed space through the introduction portion of the test plug to check the sealing performance of the seal member. When the sealing performance of the new seal member is found to be insufficient as a result of the check, the test plug is removed from the second component, the seal member attached to the attachment portion is replaced with a new seal member, and then the sealing performance of the new seal member is checked by the same procedure as described above. The procedure is repeatedly performed until a seal member having sufficient sealing performance is found. When a new seal member having sufficient sealing performance is found through the check, the new seal member is attached to the first component, and the attachment portion of the first component, to which the new seal member has been attached, is connected to the connection portion of the second component, to which the first component is to be connected.

In the check of the sealing performance of a new seal member, the closed space into which the test fluid is introduced is defined by using the test plug, and the test fluid is introduced into the closed space through the introduction portion defined in the test plug.

If the first component and the second component are connected to each other with the seal member actually attached to the first component and then the fluid that is supposed to actually flow through the fluid passage is introduced into the fluid passage defined by the connection to check the sealing performance of the new seal member, the following problem may occur. A lot of time and effort is required to connect the first component and the second component to each other to define the fluid passage and to introduce the fluid that is supposed to actually flow through the fluid passage into the fluid passage defined by the connection. Thus, a lot of time and effort is required to check the sealing performance of the seal member newly provided through the replacement.

In contrast to this, when the sealing performance of the seal member is checked using the test plug, it is no longer necessary to connect the first component and the second component to each other to define the fluid passage for the check and it is no longer necessary to introduce the fluid that is supposed to actually flow through the fluid passage into the fluid passage. As a result, it is possible to save time and effort required to connect the first component and the second component to each other to define the fluid passage and to introduce the fluid that is supposed to actually flow through the fluid passage into the fluid passage formed by the connection. Thus, it is possible to check the sealing performance of the seal member without a lot of time and effort.

The leak check device according to the above aspect may be configured such that the leak check device introduces the test fluid into the closed space through the introduction portion, with the attachment portion of the test plug connected to the second component, and the leak check device includes a checking portion that checks sealing performance of the seal member attached to the attachment portion by monitoring a pressure in the closed space after introduction of the fluid into the closed space. When the checking portion checks the sealing performance of the seal member in a case where the sealing performance of the seal member is insufficient and the leakage of the fluid occurs, the pressure in the closed space becomes low. Thus, the fact that the sealing performance of the seal member is insufficient is detected based on the pressure in the closed space.

Another aspect of the invention relates to a leak check device for a seal structure of a junction between a first component and a second component. The seal structure is configured such that a fluid passage through which a fluid flows is defined inside the first component and the second component connected to each other, a seal member is attached to the first component, and the seal member prevents the fluid from leaking to an outside through the junction. The leak check device includes a test plug.

The test plug is configured such that (a) the test plug includes an attachment portion to which the seal member is attached, (b) the attachment portion is connected to the second component separated from the first component, (c) a closed space is defined by an inner peripheral surface of the second component, an outer peripheral surface of the seal member, and an outer peripheral surface of the attachment portion, and (d) the test plug includes an introduction portion through which a test fluid is introduced into the closed space.

the leak check device may be configured to check sealing performance of the seal member such that the test fluid is introduced into the closed space through the introduction portion, with the attachment portion connected to the second component, and a pressure inside the closed space is monitored after introduction of the test fluid into the closed space.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view illustrating the entirety of a fuel supply system for an internal combustion engine;

FIG. 2 is an enlarged sectional view of a junction between a high-pressure fuel pipe and a delivery pipe in the fuel supply system;

FIG. 3 is a side view of a test plug of a leak check device; and

FIG. 4 is a schematic view illustrating the overall structure of the leak check device.

### DETAILED DESCRIPTION OF EMBODIMENTS

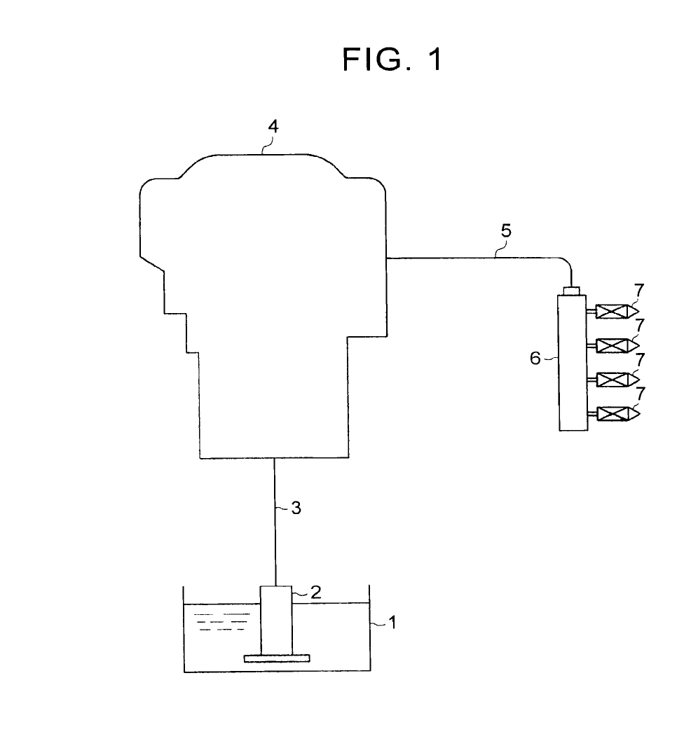

Hereinafter, a leak check device according to an embodiment of the invention will be described with reference to FIG. 1 to FIG. 4. In a fuel supply system for an internal combustion engine illustrated in FIG. 1, the fuel is drawn up from the inside of a fuel tank 1 by a feed pump 2 and discharged to a low-pressure fuel pipe 3. The low-pressure fuel pipe 3 leads to a high-pressure fuel pump 4. The high-pressure fuel pump 4 pressurizes the fuel supplied through the low-pressure fuel pipe 3, and pumps the fuel to a high-pressure fuel pipe 5 connected to the high-pressure fuel pump 4. The high-pressure fuel pipe 5 is connected to a delivery pipe 6. A plurality of injectors 7 of the internal combustion engine is connected to the delivery pipe 6. The pressurized fuel pumped from the high-pressure fuel pump 4 is supplied through the high-pressure fuel pipe 5 to the delivery pipe 6 and the injectors 7.

In the fuel supply system for the internal combustion engine, the insides of the feed pump 2, the low-pressure fuel pipe 3, the high-pressure fuel pump 4, the high-pressure fuel pipe 5, the delivery pipe 6, and the injectors 7 constitute a fluid passage through which the fuel flows from the inside of the fuel tank 1 to the inside of each injector 7. Thus, the components in the fuel supply system for the internal combustion engine, such as the feed pump 2, the low-pressure fuel pipe 3, the high-pressure fuel pump 4, the high-pressure fuel pipe 5, the delivery pipe 6, and the injectors 7, serve as multiple components that are connected to each other to define (form) the fluid passage. The fuel supply system for the internal combustion engine is provided with a seal structure configured such that a seal member provided at a junction between the components prevents the fuel inside the fluid passage from leaking to the outside through the junction.

Specifically, the components that define the fluid passage include a prescribed first component and a second component that is a component other than the first component. To connect the first component and the second component to each other, a seal member is attached to a portion of the first component to be connected to the second component, and the portion is connected to a connection portion of the second component to be connected to the first component. Thus, the seal member attached to the first component prevents the fluid inside the fluid passage from leaking to the outside through a junction between the first component and the second component. Hereinafter, the seal structure will be described. In the following description, the case where the high-pressure fuel pipe 5 is the first component and the delivery pipe 6 is the second component in the fuel supply system for the internal combustion engine will be taken as an example.

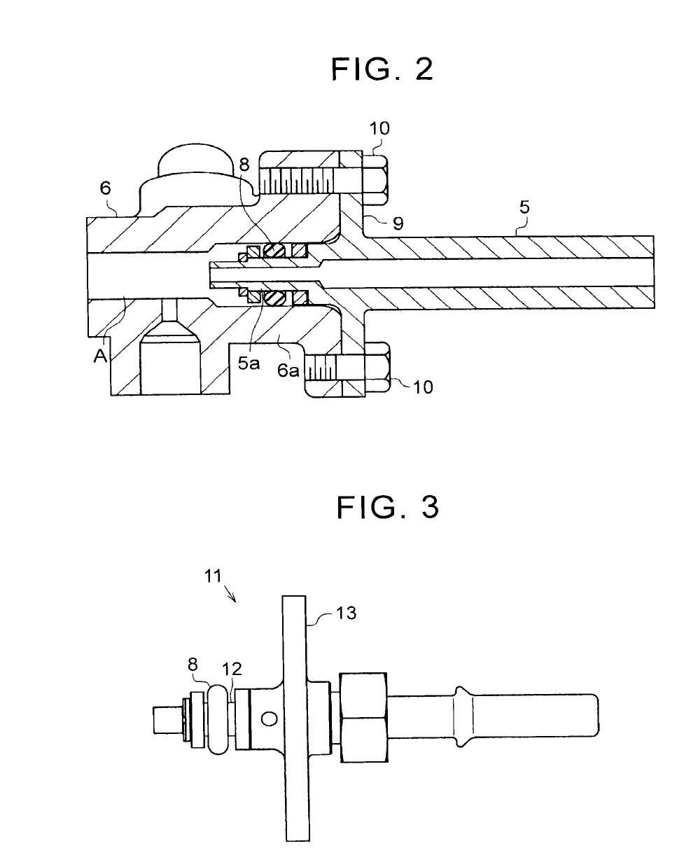

As illustrated in FIG. 2, the inner peripheral surface of a right end portion 6a of the delivery pipe 6 receives a left end portion 5a of the high-pressure fuel pipe 5, and serves as a connection portion of the delivery pipe 6, to which the high-pressure fuel pipe 5 is to be connected. An 0-ring 8, which may function as a seal member, is attached to the outer peripheral surface of the left end portion 5a of the high-pressure fuel pipe 5. The O-ring 8 is in contact with the outer peripheral surface of the left end portion 5a of the high-pressure fuel pipe 5, and is in contact also with the inner peripheral surface of the right end portion 6a of the delivery pipe 6. The O-ring 8 partitions a space that is inside the delivery pipe 6 and that is defined by the inner peripheral surface of the right end portion 6a, into a space outward (on the right side in FIG. 2) of the O-ring 8 and a space inward (on the left side in FIG. 2) of the O-ring 8.

The high-pressure fuel pipe 5 is provided with a flange 9. The left end portion 5a of the high-pressure fuel pipe 5 is secured to the right end portion 6a of the delivery pipe 6 by fastening the flange 9 to the delivery pipe 6 with bolts 10. The high-pressure fuel pipe 5 is connected to the delivery pipe 6 in this way, so that a fluid passage A through which the fuel flows is defined (formed) inside the high-pressure fuel pipe 5 and the delivery pipe 6. The fuel inside the fluid passage A that is defined as described above is prevented, by the O-ring 8, from leaking to the outside through a junction between the delivery pipe 6 and the high-pressure fuel pipe 5.

In the fuel supply system for the internal combustion engine, the high-pressure fuel pipe 5 to which the O-ring 8 is attached may be replaced with a new one together with the O-ring 8, or only the O-ring 8 that has been attached to the high-pressure fuel pipe 5 may be replaced with a new one, due to, for example, long-term use. When a new O-ring 8 is used as in these cases, it is necessary to check, in advance, whether the new O-ring 8 has sufficient sealing performance.

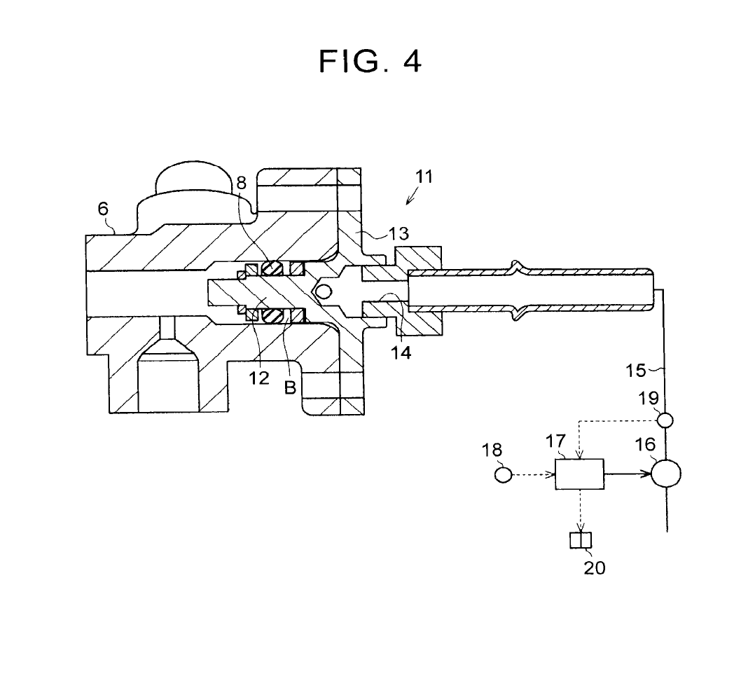

FIG. 3 illustrates a test plug 11 of the leak check device. FIG. 4 illustrates the overall structure of the leak check device. The left end portion (in FIG. 3) of the test plug 11 illustrated in FIG. 3 has an attachment portion 12 having a shape similar to that of the left end portion 5a of the high-pressure fuel pipe 5 illustrated in FIG. 2. The attachment portion 12 is configured such that the O-ring 8 can be attached thereto. The attachment portion 12 to which the O-ring 8 has been attached is inserted into the space defined by the inner peripheral surface of the right end portion 6a of the delivery pipe 6, as illustrated in FIG. 4. In other words, the attachment portion 12 of the test plug 11 to which the O-ring 8 has been attached is connected to the connection portion of the delivery pipe 6, to which the high-pressure fuel pipe 5 is to be connected. At this time, the O-ring 8 attached to the attachment portion 12 comes into contact with the inner peripheral surface of the right end portion 6a of the delivery pipe 6, thereby partitioning the space inside the delivery pipe 6 into a space outward (on the right side in FIG. 4) of the O-ring 8 and a space inward (on the left side in FIG. 4) of the O-ring 8.

As illustrated in FIG. 4, the test plug 11 includes a blocking portion 13 that comes into contact with the right end surface of the delivery pipe 6 when the attachment portion 12 is connected to the delivery pipe 6 as described above. The blocking portion 13 has the function of turning the space that is inside the delivery pipe 6 and that is outward (on the right side in FIG. 4) of the O-ring 8 attached to the attachment portion 12, into a closed space B. The closed space B sealed with the O-ring 8 attached to the attachment portion 12 of the test plug 11 and the blocking portion 13 of the test plug 11. The test plug 11 has an air introduction hole 14 leading to the closed space B. The air introduction hole 14 may function as an introduction portion through which a test fluid (air, in this example) is introduced into the closed space B.

The leak check device includes an air pipe 15 leading to the air introduction hole 14 of the test plug 11, an air pump 16 that sends the air to the air pipe 15, and a microcomputer 17 that executes drive control of the air pump 16. The microcomputer 17 executes a checking process for checking whether the O-ring 8 attached to the attachment portion 12 of the test plug 11 has sufficient sealing performance. A start switch 18, a pressure sensor 19, and a check lamp 20 are connected to the microcomputer 17. A worker turns on the start switch 18 to start the checking process. The pressure sensor 19 detects a pressure in the air pipe 15 leading to the closed space. The check lamp 20 notifies the worker of a result of the check of the sealing performance of the O-ring 8 in the checking process.

Before starting the checking process, the worker connects the test plug 11 to the delivery pipe 6 as illustrated in FIG. 4, and then turns on the start switch 18 to start the checking process with the test plug 11 connected to the delivery pipe 6. The microcomputer 17 starts the checking process in response to the turn-on of the start switch 18. In the checking process, first, the microcomputer 17 drives the air pump 16 to send the air to the air pipe 15. The air is introduced into the closed space B through the air introduction hole 14 of the test plug 11.

The microcomputer 17 stops driving of the air pump 16 when the pressure detected by the pressure sensor 19 is raised to a prescribed reference value due to the introduction of the air into the closed space B caused by the air pump 16. Because the air pipe 15 and the closed space B are communicated with each other, the pressure detected by the pressure sensor 19 is equal to the pressure inside the closed space B. After the pressure detected by the pressure sensor 19 reaches the reference value and the air pump 16 is stopped, the microcomputer 17 monitors the pressure detected by the pressure sensor 19 to check the sealing performance of the O-ring 8 attached to the attachment portion 12 of the test plug 11.

More specifically, when the pressure detected by the pressure sensor 19 is significantly lower than a prescribed determination value after a lapse of a prescribed time from the stop of the air pump 16, the microcomputer 17 determines that the sealing performance of the O-ring 8 is insufficient. On the other hand, when the pressure detected by the pressure sensor 19 is not significantly lower than the prescribed determination value after a lapse of the prescribed time from the stop of the air pump 16, the microcomputer 17 determines that the O-ring 8 has sufficient sealing performance. When determining that the sealing performance of the O-ring 8 is insufficient, the microcomputer 17 illuminates the check lamp 20, for example, in red to notify the worker that the sealing performance of the O-ring 8 is insufficient. On the other hand, when determining that the O-ring 8 has sufficient sealing performance, the microcomputer 17 illuminates the check lamp 20, for example, in green to inform the worker that the O-ring 8 has sufficient sealing performance.

When the sealing performance of the new O-ring 8 attached to the attachment portion 12 of the test plug 11 is found to be insufficient through the checking process, the test plug 11 is removed from the delivery pipe 6 and the O-ring 8 is replaced with another O-ring 8. Then, the sealing performance of the new O-ring 8 is checked by the same procedure as described above through the checking process. The procedure is repeatedly performed until an O-ring 8 having sufficient sealing performance is found. When a new O-ring 8 having sufficient sealing performance is found through the check, the O-ring 8 is removed from the test plug 11 and attached to the outer peripheral surface of the left end portion 5a of the high-pressure fuel pipe 5 illustrated in FIG. 2, and the left end portion 5a of the high-pressure fuel pipe 5 is connected to the right end portion 6a of the delivery pipe 6. Specifically, the left end portion 5a of the high-pressure fuel pipe 5 to which the O-ring 8 is attached is inserted into the right end portion 6a of the delivery pipe 6 and the flange 9 of the high-pressure fuel pipe 5 is fastened to the delivery pipe 6 with the bolts 10, so that the left end portion 5a of the high-pressure fuel pipe 5 is secured to the right end portion 6a of the delivery pipe 6.

Next, the operation of the leak check device will be described. In the check of the sealing performance of the new O-ring 8, the closed space B into which the testing air is introduced is provided with the use of the test plug 11, and the testing air is introduced into the closed space B through the air introduction hole 14 of the test plug 11.

If the high-pressure fuel pipe 5 and the delivery pipe 6 are connected to each other with the new O-ring 8 actually attached to the high-pressure fuel pipe 5 and then the fluid (fuel, in this example) that is supposed to actually flow through the fluid passage A is introduced into the fluid passage A defined by the connection to check the sealing performance of the new O-ring 8, the following problem may occur. A lot of time and effort is required to connect the high-pressure fuel pipe 5 and the delivery pipe 6 to each other to define the fluid passage A and to introduce the fluid (fuel) that is supposed to actually flow through the fluid passage A into the fluid passage A defined by the connection. Thus, a lot of time and effort is required to check the sealing performance of the O-ring 8 newly provided through the replacement.

In contrast to this, when the sealing performance of the O-ring 8 is checked using the test plug 11, it is no longer necessary to connect the high-pressure fuel pipe 5 and the delivery pipe 6 to each other to define the fluid passage A for the check and it is no longer necessary to introduce the fluid (fuel) that is supposed to actually flow through the fluid passage A into the fluid passage A. As a result, it is possible to save time and effort required to connect the high-pressure fuel pipe 5 and the delivery pipe 6 to each other to define the fluid passage A and to introduce the fluid (fuel) that is supposed to actually flow through the fluid passage A into the fluid passage A formed by the connection.

The above-described embodiment produces the following advantageous effects. (1) The sealing performance of the O-ring 8 is checked without a lot of time and effort. (2) Even when the sealing performance of the new O-ring 8 is insufficient and the check for sealing performance is repeatedly performed until a new O-ring 8 having sufficient sealing performance is found, it is no longer necessary to repeatedly connect the high-pressure fuel pipe 5 and the delivery pipe 6 to each other and disconnect the high-pressure fuel pipe 5 and the delivery pipe 6 from each other in order to repeatedly replace the O-ring 8 with another one and repeatedly define (form) the fluid passage A. Further, it is no longer necessary to actually introduce the fuel into the fluid passage A every time the fluid passage A is defined (formed). As a result, it is possible to save time and effort for the check for sealing performance, even when the check for sealing performance needs to be repeatedly performed until a new O-ring 8 having sufficient sealing performance is found.

(3) The test fluid (air) is introduced into the closed space B through the air introduction hole 14 of the test plug 11. Thus, the delivery pipe 6 need not be subjected to machining for forming, for example, a through-hole through which the test fluid is introduced into the closed space B.

(4) The air is used as the test fluid. Thus, even when the air leaks from the closed space B during the check for the sealing performance of the O-ring 8, the leakage does not adversely affect the surroundings.

The foregoing embodiment may be modified, for example, as follows. A gas other than air or a liquid, such as fuel, may be used as the test fluid. When a liquid is used as the test fluid, whether the O-ring 8 has sufficient sealing performance may be determined by a worker's visual check for leakage of the liquid.

While the example in which the high-pressure fuel pipe 5 and the delivery pipe 6 connected to each other are used respectively as the first component and the second component has been described above, the first component and the second component may be two components connected to each other among the components constituting the fuel supply system for the internal combustion engine, other than the combination of the high-pressure fuel pipe 5 and the delivery pipe 6.

The leak check device may be applied to a seal structure of a junction between components for defining a fluid passage in a system other than the fuel supply system for the internal combustion engine.

What is claimed is:

1. A leak check device for a seal structure configured such that a seal member attached to a first component connected to a second component to define a fluid passage prevents a fluid inside the fluid passage from leaking to an outside through a junction between the first component and the second component, the leak check device comprising:
a test plug including an attachment portion to be connected to the second component separated from the first component, the attachment portion being connected to the second component with the seal member attached to the attachment portion;
a blocking portion provided on the test plug, the blocking portion turning a space inside the second component, the space being outward of the seal member, into a closed space when the attachment portion is connected to the second component; and
an introduction portion through which a test fluid is introduced into the closed space, the introduction portion being defined in the test plug.

2. The leak check device according to claim 1, wherein:
the leak check device introduces the test fluid into the closed space through the introduction portion, with the attachment portion of the test plug connected to the second component; and
the leak check device includes a checking portion that checks sealing performance of the seal member attached to the attachment portion by monitoring a pressure in the closed space after introduction of the fluid into the closed space.

3. A leak check device for a seal structure of a junction between a first component and a second component,
the seal structure configured such that
a fluid passage through which a fluid flows is defined inside the first component and the second component connected to each other,
a seal member is attached to the first component, and
the seal member prevents the fluid from leaking to an outside through the junction,
the leak check device comprising
a test plug configured such that
(a) the test plug includes an attachment portion to which the seal member is attached,
(b) the attachment portion is connected to the second component separated from the first component,
(c) a closed space is defined by an inner peripheral surface of the second component, an outer peripheral surface of the seal member, and an outer peripheral surface of the attachment portion, and
(d) the test plug includes an introduction portion through which a test fluid is introduced into the closed space.

4. The leak check device according to claim 3, wherein
the leak check device is configured to check sealing performance of the seal member such that
the test fluid is introduced into the closed space through the introduction portion, with the attachment portion connected to the second component, and
a pressure inside the closed space is monitored after introduction of the test fluid into the closed space.
